(19) United States
(12) Patent Application Publication
(10) Pub. No.: US 2008/0026181 A1
(43) Pub. Date: Jan. 31, 2008

(54) Synergistically-modified surfaces and surface profiles for use with thermal interconnect and interface materials, methods of production and uses thereof

(76) Inventors: Ravi Rastogi, Liberty Lake, WA (US); Martin W. Weiser, Liberty Lake, WA (US)

Correspondence Address: BUCHALTER NEMER, 18400 VON KARMAN AVE., SUITE 800, IRVINE, CA, 92612, US

(21) Appl. No.: 11/493,778

(22) Filed: Jul. 25, 2006

(51) Int. Cl. G11B 5/64

(52) U.S. Cl. 428/141

(57) ABSTRACT

Synergistically-modified surfaces are described herein, where a surface having a surface profile is synergistically modified such that the thermal contact resistance between the surface and the at least one thermal interface material is reduced as compared to a surface that is not synergistically modified. Methods are also described herein of producing a synergistically-modified surface, comprising a) providing a surface having a surface profile, b) providing at least one thermal interface material, c) synergistically modifying the surface profile of the surface such that thermal contact resistance between the surface and the at least one thermal interface material is reduced as compared to a surface that is not synergistically modified. Layered components are also disclosed that comprise a synergistically-modified surface; a thermal interface material; and at least one additional layer of material.

### FIELD OF THE INVENTION

The field of the invention is thermal interconnect systems, thermal interface systems and interface materials, including synergistic modification of the surface profile, in electronic components, semiconductor components and other related layered materials applications.

### BACKGROUND

Electronic components are used in ever increasing numbers in consumer and commercial electronic products. Examples of some of these consumer and commercial products are televisions, personal computers, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging. Products and components also need to be prepackaged, such that the product and/or component can perform several related or unrelated functions and tasks. Examples of some of these “total solution” components and products comprise layered materials, mother boards, cellular and wireless phones and telecommunications devices and other components and products, such as those found in US patent and PCT Application Serial Nos.: 60/396,294 filed Jul. 15, 2002, 60/294,433 filed May 30, 2001, Ser. No. 10/519,337 filed Dec. 22, 2004, Ser. No. 10/551,305 filed Sep. 28, 2005, Ser. No. 10/465,968 filed Jun. 26, 2003 and PCT/US02/17331 filed May 30, 2002, which are all commonly owned and incorporated herein in their entirety.

Components, therefore, are being broken down and investigated to determine if there are better building materials and methods that will allow them to be scaled down and/or combined to accommodate the demands for smaller electronic components. In layered components, one goal appears to be decreasing the number of the layers while at the same time increasing the functionality and durability of the remaining layers and surface/support materials. This task can be difficult, however, given that several of the layers and components of the layers should generally be present in order to operate the device.

Also, as electronic devices become smaller and operate at higher speeds, energy emitted in the form of heat increases dramatically. A popular practice in the industry is to use thermal grease, or grease-like materials, alone or on a carrier in such devices to transfer the excess heat dissipated across physical interfaces. Most common types of thermal interface materials are thermal greases, phase change materials, and elastomer tapes. Thermal greases or phase change materials have lower thermal resistance than elastomer tape because of the ability to be spread in to very thin layers and provide intimate thermal contact between adjacent surfaces. Typical thermal impedance values range between 0.05-1.6° C.-cm²/W. However, a serious drawback of thermal grease is that thermal performance deteriorates significantly after thermal cycling, such as from −65° C. to 150° C., or after power cycling when used in VLSI chips. It has also been found that the performance of these materials deteriorates when large deviations from surface planarity cause gaps to form between the mating surfaces in the electronic devices or when large gaps between mating surfaces are present for other reasons, such as manufacturing tolerances, etc. When the heat transferability of these materials breaks down, the performance of the electronic device in which they are used is adversely affected.

Thus, there is a continuing need to: a) design and produce thermal interconnects and thermal interface materials, layered materials, components and products that meet customer specifications while minimizing the size of the device and number of layers; b) produce more efficient and better designed materials, products and/or components with respect to the compatibility requirements of the material, component or finished product; c) produce materials and layers that are more compatible with other layers, surfaces and support materials at the interface of those materials; d) develop reliable methods of producing desired thermal interconnect materials, thermal interface materials and layered materials and components/products comprising contemplated thermal interface and layered materials; e) develop materials that possess a high thermal conductivity and a high mechanical compliance; f) effectively reduce the number of production steps necessary for package assembly, which in turn results in lower cost of ownership over other conventional layered materials and processes; and g) effectively reduce the thermal contact resistance between a surface and a thermal interface material.

### SUMMARY

Synergistically-modified surfaces are described herein, where a surface having a surface profile is synergistically modified such that the thermal contact resistance between the surface and the at least one thermal interface material is reduced as compared to the thermal contact resistance between the surface that is not synergistically modified and the at least one thermal interface material (TIM).

Methods are also described herein of producing a synergistically-modified surface, comprising a) providing a surface having a surface profile, b) providing at least one thermal interface material, c) synergistically modifying the surface profile of the surface such that thermal contact resistance between the surface and the at least one thermal interface material is reduced as compared to a surface that is not synergistically modified.

Layered components are also disclosed that comprise a synergistically-modified surface; a thermal interface material; and at least one additional layer of material.

### BRIEF DESCRIPTION OF THE FIGURES

FIG. 1 shows a graph of contemplated synergistically-modified surface materials, as compared with conventional materials and surfaces.

FIG. 2 shows a graph of the effect of the surface machining method on the thermal impedance of a nickel-plated surface.

FIG. 3 shows a graph of the thermal impedance versus the surface roughness as measured by a scanning laser profilometer.

FIG. 4 shows a graph of the thermal impedance as a function of the chemical profile of the surface.

FIG. 5 shows a graph of the thermal impedance as a function of how long the surfaces were exposed to air after subtractive surface modification.

### DETAILED DESCRIPTION

A suitable interface material or component should conform to the mating surfaces (deforms to fill surface contours and “wets” the surface), possess a low bulk thermal resistance and possess a low thermal contact resistance. Bulk thermal resistance can be expressed as a function of the material's or component's thickness, thermal conductivity and area. Thermal contact resistance is a measure of how well a material or component is able to transfer heat across the interface which is largely determined by the amount and type of contact between the two materials. One of the goals of the materials and methods described herein is to minimize thermal contact resistance without a significant loss of performance from the materials. The thermal resistance of an interface material or component can be shown as follows:

Θinterface=t/k+2Θ_{contact} Equation 1

where
Θ is the thermal resistance,
t is the material thickness,
k is the thermal conductivity of the material

The term “t/k” represents the thermal resistance of the bulk material and “2Θ_{contact}” represents the thermal contact resistance at the two surfaces. A suitable interface material or component should have a low bulk resistance and a low thermal contact resistance, i.e. at the mating surface.

Thermal impedance (TI) is a practical way to measure the thermal contact resistance of a TIM. ASTM standard D5470-06 addresses the measurement of thermal impedance. Thermal impedance includes the area of the sample and therefore has units of ° C.-cm²/W while the units for thermal contact resistance are ° C./W. The thermal impedance measurement includes the three terms in equation 1. Measuring the TI as a function of bond line thickness (BLT) while using the same surface profile results in constant thermal contact resistance and allows calculation of the thermal conductivity of the TIM. If both the BLT and thermal conductivity of the TIM are held constant then any differences in the measured TI will be due to differences in the thermal contact resistance which are due to differences in the surface profile.

Many electronic and semiconductor applications require that the interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. Also, for such applications, differences in CTE between the mating components cause the gap to expand and contract due to warpage with each temperature or power cycle. This variation of the interface thickness can cause pumping of fluid interface materials (such as grease) away from the interface.

Interfaces with a larger area are more prone to deviations from surface planarity as manufactured. To optimize thermal performance, the interface material should be able to conform to non-planar surfaces and thereby achieve lower thermal resistance. As used herein, the term “interface” means a couple or bond that forms the common boundary between two parts of matter or space, such as between two molecules, two backbones, a backbone and a network, two networks, etc. An interface may comprise a physical attachment of two parts of matter or components or a physical attraction between two parts of matter or components, including bond forces such as covalent and ionic bonding, Van der Waals, diffusion bonding, hydrogen bonding and non-bond forces such as electrostatic, coulombic, and/or magnetic attraction. Contemplated interfaces include those interfaces that are formed with bond forces, such as covalent and metallic bonds; however, it should be understood that any suitable adhesive attraction or attachment between the two parts of matter or components is preferred.

Optimal interface materials and/or components possess high thermal conductivity to effectively remove heat and a high mechanical compliance so they will yield elastically or plastically at the local level when force is applied. High thermal conductivity reduces the first term of Equation 1 while high mechanical compliance reduces the second term. The layered interface materials and the individual components of the layered interface materials described herein accomplish these goals. When properly produced, the thermal interface component described herein will span the distance between the mating surfaces, e.g. that of the heat spreader material and the silicon die component, thereby allowing a high conductivity path from one surface to the other surface. Suitable thermal interface components comprise those materials that can conform to the mating surfaces (deform to fill surface contours and wet the surface), possess a low bulk thermal resistance and possess a low thermal contact resistance

As mentioned earlier, the main goals of developing an effective system of thermal interface materials, layered interface materials and individual components described herein are to: a) design and produce thermal interconnects and thermal interface materials, layered materials, components and products that meet customer specifications while minimizing the size of the device and number of layers; b) produce more efficient and better designed materials, products and/or components with respect to the compatibility requirements of the material, component or finished product; c) produce materials and layers that are more compatible with other layers, surfaces and support materials at the interface of those materials; d) develop reliable methods of producing desired thermal interconnect materials, thermal interface materials and layered materials and components/products comprising contemplated thermal interface and layered materials; e) develop materials that possess high thermal conductivity and high mechanical compliance; f) effectively reduce the number of production steps necessary for package assembly, which in turn results in lower cost of ownership over other conventional layered materials and processes; and g) effectively reduce the thermal contact resistance between a surface and a thermal interface material.

Materials and modified surfaces/support materials for pre-attached/pre-assembled thermal solutions and/or IC (interconnect) packages are provided herein. In addition, thermal solutions and/or IC packages that comprise one or more of these materials and modified surface/support materials described herein are contemplated. Ideally, contemplated components of a suite of thermal interface materials exhibit low thermal resistance for a wide variety of interface conditions and demands. Thermal interface materials contemplated herein can be used to attach the heat generating electronic devices (e.g. the computer chip) to the heat dissipating structures (e.g. heat spreaders, heat sinks). The performance of the thermal interface materials is one of the most important factors in ensuring adequate and effective heat transfer in these devices. The modified surfaces/support materials described herein and how they interact with the thermal interface materials are novel in that they combine components in amounts and ways not yet contemplated or disclosed in other related art.

As mentioned, the thermal interface materials and modified surfaces described herein, which are also described in US patent application entitled “Thermal Interconnect and Interface Materials, Methods of Production and Uses Thereof”, which is commonly-owned and incorporated herein by reference in its entirety, may be utilized in total solution packaging, such as in a combo-spreader or layered component. The synergistically-modified surfaces and surface profiles described herein accomplish these goals.

Synergistically-modified surfaces are described herein, where a surface having a surface profile is synergistically modified such that the thermal contact resistance between the surface and the at least one thermal interface material is reduced as compared to a surface that is not synergistically modified (a “nonsynergistically-modified surface”, as is also used herein). In some embodiments, the thermal contact resistance of a synergistically modified surface and at least one thermal interface material is reduced by at least 5% as compared to a surface that is not synergistically modified coupled with at least one thermal interface material. In other embodiments, the thermal contact resistance of a synergistically modified surface and at least one thermal interface material is reduced by at least 10% as compared to a surface that is not synergistically modified coupled with at least one thermal interface material. In yet other embodiments, the thermal contact resistance of a synergistically modified surface and at least one thermal interface material is reduced by at least 20% as compared to a surface that is not synergistically modified coupled with at least one thermal interface material. In additional embodiments, the thermal contact resistance of a synergistically modified surface and at least one thermal interface material is reduced by at least 40% as compared to a surface that is not synergistically modified coupled with at least one thermal interface material. In other additional embodiments, the thermal contact resistance of a synergistically modified surface and at least one thermal interface material is reduced by at least 75% as compared to a surface that is not synergistically modified coupled with at least one thermal interface material.

Substrates and/or surfaces contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated lead frame, a copper, nickel, or gold plated heat spreader or thermal lid, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide. The “substrate” may even be defined as another polymer material when considering cohesive interfaces. In more preferred embodiments, the substrate comprises a material commonly found in the packaging and circuit board industries such as silicon, copper, glass, and another polymer.

Contemplated layered materials and interfaces that utilize thermal interface materials, such as those mentioned above, may comprise at least one surface or support material having a surface profile. As used herein, the phrase “surface profile” is understood to mean the combination of the chemical profile and the physical profile of the surface material and/or support material. It is understood that the modified surface profile may be produced by altering the chemical profile of the surface profile, the physical profile of the surface profile or a combination of both.

In contemplated embodiments, the surface profile of a surface is modified by either at least one additive process, at least one subtractive process or a combination thereof. As used herein, the phrase “additive process” describes a process whereby a material, composition or other compound is added to the surface in order to change or modify the surface profile of the surface. As used herein, the phrase “subtractive process” describes a process whereby at least part of the surface is removed or displaced (scarifying) in order to change or modify the surface profile of the surface. If at least part of the surface is not being physically or chemically removed from the remaining surface, then the process is considered additive for the purposes of this disclosure. In some embodiments, the surface or surface profile is synergistically modified in a random manner or in a non-random manner. For instance, if the surface is synergistically modified in a pattern form, this pattern form would be considered a non-random manner.

The chemical profile of the surface may be modified by either materially changing the surface material or applying another material to the surface—either of which could be considered additive processes. It should be noted that if another material is applied to the surface to change or modify the chemical profile of the surface that the physical profile of the surface may also be modified at the same time through planarization or chemical roughening/unevening (chemical treatment) of the surface or a combination thereof. Introducing a metal-based layer, coating and/or film, such as those described in U.S. application Ser. No. 11/334,637 filed Jan. 18, 2006 is considered both a chemical profile and a physical profile modification of the surface profile. It is contemplated that a suitable additive process includes electroplating, spot plating, plasma spray, melt spray, evaporation, sputtering, soldering, brazing, ultrasonic soldering or a combination thereof.

In a contemplated embodiment, the surface profile of a surface may be modified by a subtractive process. For example, the original surface may comprise an oxide layer, such as native nickel oxide, which is deleterious to the final thermal performance of the layered material or component. In this case, the surface profile comprises both the oxide layer and the underlying material, since both contribute to the total surface material and its properties. A subtractive process, such as plasma etch cleaning; can be used right before application of the thermal interface material in order to synergistically modify the surface profile of the surface. The subtractive process of removing the oxide layer can be followed by an additive process whereby a protective barrier or coating is applied to the surface before application of the thermal interface material. In this embodiment, the subtractive process of removing the oxide layer and the additive process of applying a coating or protective barrier simultaneously work to synergistically modify the surface profile of the surface to better suit or be more compatible with the thermal interface material or composition, and thus enhance the overall thermal performance of the system. In some contemplated embodiments, contemplated subtractive processes include eletro-etching, plasma etching, lapping, sanding, grinding, roughening or a combination thereof.

In another embodiment, as mentioned, the surface profile is modified by a subtractive process in order to remove at least part of the surface in order to “roughen” the surface. It has been found that the thermal impedance of thermal interface materials, such as those described herein, is higher and the ability to remove heat lower when the surface of the heat spreader or electronic device is very smooth, such as when it is fly cut. A rougher surface such as that created by surface grinding results in a lower TI and hence better heat removal. Lapping or grinding the surface with a fine grit such as 10 micron SiC paper reduces the thermal impedance even further. However, polishing with very fine abrasives is believed to be detrimental since it results in a surface that is similar to a fly cut surface based upon SEM observations. One possible explanation for the effect of surface roughness is that a rougher surface results in a larger effective area for the TIM to make physical and thermal contact with the heat spreader. This in effect reduces the interfacial thermal resistance, which in conjunction with the bulk resistance makes up the total thermal impedance of the TIM joint. There are several additional methods to make the surface rougher including grinding, bead blasting, lapping, and deburring. Current data indicates that methods such as lapping or grinding that increase the roughness at a fine scale (0.5-50 μm) may be more effective in reducing the thermal impedance than those methods that increase the coarser roughness as measured by typical profilometers. In some embodiments, these processes create a surface roughness on the about 0.5 to about 20 micrometer scale.

As background and as mentioned earlier, the surface profile (which includes mechanical features) includes the flatness and roughness of the surface. These properties are normally measured with a profilometer. A variety of profilometers are used in the industry including mechanical profilometers and the laser profilometer that we use. There are both advantages and limits, particularly around spatial resolution, to each of these techniques that will have bearing on how well they are able to describe the surface characteristics that are important to the thermal performance. In addition, techniques such as scanning electron microscopy (SEM—qualitative) and atomic force microscopy (AFM—quantitative) can be used to characterize a small portion of the surface at sub-micrometer resolution. It has now been discovered that surfaces that have essentially the same roughness as measured by laser profilometery can have very significantly different thermal performance and exhibit significant differences in their surface profiles in the SEM, and possibly AFM.

In another embodiment, the surface profile may be synergistically modified by coating the surface with a metal or metal-based coating. This process would be considered an additive process. As mentioned earlier, the chemistry of the surface will also impact the thermal impedance (TI). It has been discovered that exposed copper or gold-plated surfaces result in a lower TI compared to the TIs obtained on the Ni-plated surfaces. In practical application on heat spreaders, modified surface chemistry could be achieved by either plating a gold or copper spot using a variety of different methods, such as those found in U.S. application Ser. No. 10/542,040 filed on Jul. 13, 2005 or 60/448,722 filed on Feb. 19, 2003, which are both commonly-owned and incorporated herein. In contemplated embodiments, metal-based coating layers may comprise any suitable metal that can be laid down on the surface of the thermal interface material or on the surface/support material in a layer. In some embodiments, the metal-based coating layer comprises indium, such as from indium metal, In33Bi, In33BiGd and In3Ag, or gold, copper, or silver. These metal-based coating layers are generally laid down by any method capable of producing a uniform layer with minimal pores or voids and which can further lay down the layer with a relatively high deposition rate. Many suitable methods and apparatus are available to lay down layers or ultra thin layers of this type, such as sputtering, evaporation, spot plating, or pulse plating. Pulse plating (which is intermittent plating as opposed to direct current plating) can lay down layers that are free or virtually free of pores and/or voids.

In yet another embodiment, which is similar to one mentioned earlier and which would be considered a subtractive process, the nickel plating can be stripped from the copper heat spreader from the area of application in order to partially or fully expose the copper surface. The possible explanation for surface chemistry effect is that some surfaces (e.g. Au, Cu) are wet better than others (e.g. Ni) by the molten solder during curing.

Methods are also described herein of producing a synergistically-modified surface, comprising a) providing a surface having a surface profile, b) providing at least one thermal interface material, c) synergistically modifying the surface profile of the surface such that the thermal contact resistance between the surface and the at least one thermal interface material is reduced as compared to the thermal contact resistance between the TIM and a surface that is not synergistically modified.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include indium, silver, copper, aluminum, tin, bismuth, lead, gallium and alloys thereof, silver coated copper, and silver coated aluminum. The term “metal” also includes alloys, metal/metal composites, metal ceramic composites, metal polymer composites, as well as other metal composites. As used herein, the term “compound” means a substance with constant composition that can be broken down into elements by chemical processes. As used herein, the phrase “metal-based” refers to any coating, film, composition or compound that comprises at least one metal.

Coating layers, additive layers, metal layers, thermal interface materials and related layers can be laid down in any suitable thickness, depending on the needs of the electronic component and the vendor as long as the thermal interface component is able to sufficiently perform the task of dissipating some or all of the heat generated from the surrounding electronic component. In some embodiments, the thicknesses of contemplated layers are less than about 1 mm. In other embodiments, contemplated thicknesses comprise thicknesses in the range of about 0.05-0.50 μm. In some embodiments, contemplated thicknesses of additive layers are within the range of about 0.50-5 μm. In other embodiments, contemplated thicknesses of additive layers are within the range of about 1-50 μm.

In some embodiments, oxidation of the surface is a undesirable effect after additive or subtractive treatment. Thermal interface materials can be applied to the surface, sometimes immediately, after treatment in order to limit oxidation. In other embodiments, a protective layer is applied, again sometimes immediately, after treatment and before application of a thermal interface material or other layer, in order to limit oxidation. In yet other embodiments, any combination of additional layers may be added in a random or non-random manner in order to protect the synergistically-modified surface and/or to increase the thermal impedance or thermal contact resistance, as with those thermal interface materials that are disclosed in US patent application entitled: “Thermal Interconnect and Interface Materials, Methods of Production and Uses Thereof”, which was filed on Jul. 25, 2006, is incorporated herein by reference in its entirety and which is commonly-owned by Honeywell International Inc.

When using a metallic thermal interface material, like solder, which has a high elastic modulus compared to most polymer systems, it may be necessary to reduce the mechanical stresses transferred to the semiconductor die due to coefficient of thermal expansion mismatch in order to prevent cracking of the die. This stress transfer can be minimized by a) increasing the bondline thickness of the metallic thermal interface material, b) reducing the coefficient of thermal expansion of the heat spreader, or c) changing the geometry of the heat spreader to minimize stress transfer. Examples of lower coefficient of thermal expansion (CTE) materials are AlSiC, CuSiC, copper-graphite composites, carbon-carbon composites, diamond, CuMoCu laminates, etc. Examples of geometric changes are adding a partial or through slot to the spreader to decrease spreader thickness, or forming a truncated, square based, inverted pyramid shape to lower stress and stiffness by having the spreader cross-section be lower near the semiconductor die.

In some contemplated embodiments, thermal interface materials can be directly deposited onto at least one of the sides of the surface, such as a heat spreader component, including the bottom side, the top side or both. In some contemplated embodiments, the thermal interface material is stencil or screen printed or dispensed directly onto the heat spreader by methods such as jetting, thermal spray, liquid molding or powder spray. In yet other contemplated embodiments, a film of thermal interface material is deposited and combined with other methods of building adequate thermal interface material thickness, including direct attachment of a preform or stencil printing of a thermal interface material paste.

Methods of forming layered thermal interface materials and thermal transfer materials include: a) providing a heat spreader component, wherein the heat spreader component comprises a top surface, a bottom surface and at least one heat spreader material; b) providing at least one thermal interface material, such as those described herein, wherein the thermal interface material is directly deposited onto the bottom surface of the heat spreader component; c) depositing, applying or coating a metal-based coating, film or layer on at least part of the bottom surface of the heat spreader component; and d) depositing, applying or coating the at least one thermal interface material onto at least part of at least one of the surfaces of the heat spreader component where the surface has been modified.

Once deposited, applied or coated, the thermal interface material layer comprises a portion that is directly coupled to the heat spreader material and a portion that is exposed to the atmosphere, or covered by a protective layer or film that can be removed just prior to installation of the heat spreader component. Additional methods include providing at least one adhesive component and coupling the at least one adhesive component to at least part of at least one of the surfaces of the at least one heat spreader material and/or to at least part of the thermal interface material. At least one additional layer, including a substrate layer, can be coupled to the layered interface material.

Pre-attached/pre-assembled thermal solutions and/or IC (interconnect) packages comprise one or more components of the thermal interface materials described herein and at least one adhesive component. These thermal interface materials exhibit low thermal resistance for a wide variety of interface conditions and demands. As used herein, the term “adhesive component” means any substance, inorganic or organic, natural or synthetic, that is capable of bonding two or more pieces of the same substance or different substances together by surface attachment. In some embodiments, the adhesive component may be added to or mixed with the thermal interface material, may actually be the thermal interface material or may be coupled, but not mixed, with the thermal interface material. Examples of some contemplated adhesive components comprise double-sided tape from SONY, such as SONY T4411 and SONY T4100D203, or from 3M such as 3M F9460PC. In other embodiments, the adhesive may serve the additional function of attaching the heat spreading component to the package substrate independent of the thermal interface material.

Additional layers of material may be coupled to the thermal interface materials or layered interface materials in order to continue building a layered component or printed circuit board. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

Several methods and many thermal interface materials can be utilized to form these pre-attached/pre-assembled thermal solution components. A method for forming the thermal solution/package and/or IC package includes: a) providing the thermal interface material or layered interface material described herein; b) providing at least one adhesive component; c) providing at least one surface or substrate; d) coupling the at least one thermal interface material and/or layered interface material with the at least one adhesive component to form an adhesive unit; e) coupling the adhesive unit to the at least one surface or substrate to form a thermal package; f) optionally coupling an additional layer or component to the thermal package.

Applications of the contemplated thermal solutions, IC Packages, thermal interface components, layered interface materials and heat spreader components described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

### EXAMPLES

The information presented herein in the Examples section should be utilized by one of ordinary skill in the art to understand the breadth and application of the subject matter disclosed herein. Some of this information is also presented in “Impact of Application Surface on The Development of Thermal Interface Materials” by Martin W. Weiser, Devesh Mathur and Ravi Rastogi for The Proceedings of the IMAPS 39^{th} International Symposium on Microelectronics, San Diego, Calif. Oct. 8-12, 2006, which is incorporated herein by reference in its entirety.

### TI and BLT Measurement

The thermal performance of the TIM was measured using a custom thermal impedance (TI) test system based upon ASTM D5470-06. The test blocks were made from oxygen free high conductivity (OFHC) copper rod 2.54 cm in diameter and 1.78 cm tall. The blocks each had three 1.18 mm diameter thermocouple holes drilled to the centerline from one side along their length to allow measurement of the temperature gradient. This permits calculation of the heat flux in the test stack and projection of the interface temperature where the test block meets the TIM being tested.

The TIM was spread on the top circular surface of the lower test block to a thickness of approximately 0.25 mm (0.010″) and two 50 μm spacers made from chromel wire were placed approximately 6 mm apart. The upper block was then positioned above the TIM and gently pressed into place. The test blocks were then loaded into the TI test system and the uncured thermal impedance was measured with a heater input of 140 W at a pressure of 276 kPa (40 psi).

After testing in the uncured condition, the TIM/block assembly was cured at 150° C. for 40 minutes with a dead weight load that yielded a 207 kPa (30 psi) pressure. They were then retested at 140 W and 276 kPa (40 psi) pressure.

Bare copper, nickel-plated, and nickel plus gold-plated copper thermal impedance test blocks based on ASTM D5470 were used to test the performance of a polymer solder hybrid under various conditions as described in the table below. The thermal interface material used in the data collected for the figures below comprises 46.2% Sn35In5Bi powder, 23.8% large silver powder (TECHNIC), 23.8% small silver powder (METALOR) and 6.2% resin formulation. In these examples the same TIM was used for each test and the BLT was held constant so changes in the measured TI are due to changes in the thermal contact resistance from the synergistic modification of the surfaces of the test blocks.

| Code | Test block preparation method |
|---|---|
| A | Turned and Ni-plated (baseline blocks) |
| B | Turned, lapped on 10 μm SiC, and Ni-plated |
| C | Turned, Ni plated, and lapped on 10 μm SiC |
| D | Flycut and Ni-plated |
| E | Surface ground and Ni-plated |
| F | Surface ground, Ni-plated, and lapped on 10 μm SiC |
| G | Flycut Cu surface |
| H | Turned Cu surface |
| I | Flycut and Ni/Au-plated + baseline Ni-plated block |
| J | Au plating over baseline Ni-plated blocks |
| K | Lap the Ni-plated block with 6 μm diamond paste and store in air |
| | at room temperature for 3 hrs before assembly and test |
| L | Lap the Ni-plated block with 6 μm diamond paste and stored in a |
| | vacuum of 10⁻² Pa for 5 hrs before assembly and test |
| M | Lap the Ni-plated block with 6 μm diamond paste and store in air |
| | for 5 minutes before assembly and test |
| N | Lap the Ni-plated block with 6 μm diamond paste and store in air |
| | for 2 minutes before assembly and test |

The results are plotted in FIG. 1, and indicate a lower thermal impedance of the parts that are synergistically treated compared to baseline Ni-plated blocks. The codes in the figure are described in the table above.

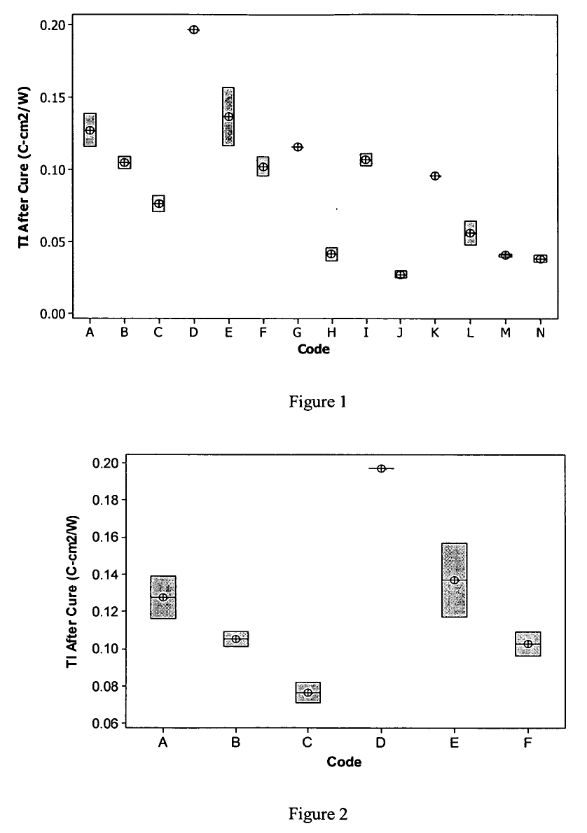

The effect of the machining method used to prepare the surface of the thermal impedance block is shown in FIG. 2. Lapping the baseline turned surface on 10 μm SiC paper reduces the thermal impedance, particularly when it is done after plating as shown by the sequence of codes A through C. Using a fly cutter to machine the surface increases the thermal impedance as shown by code D. Machining the surface with a surface grinder results in similar thermal impedance as lathe turning the surfaces with SiC lapping after plating. However, it is not quite as effective in reducing the thermal impedance with this treatment (codes E and F).

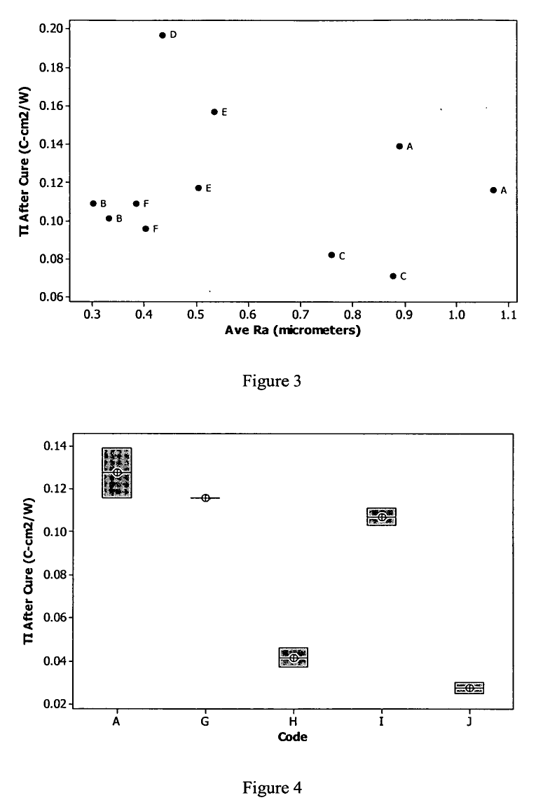

The roughness of the surfaces was measured using a scanning laser profilometer (UBM Corporation, Sunnyvale Calif.). This was done to determine if the visible differences in the surface profile as evaluated with the approximately 10 μm diameter probe (as estimated from the laser spot size) could be correlated with the thermal impedance measured for the respective blocks. As seen in FIG. 3 the thermal impedance and surface roughness are not correlated at this length scale. Therefore, the differences in the thermal impedance could be a result of the finer scale changes that can be observed in the scanning electron and may be observed in the atomic force microscope.

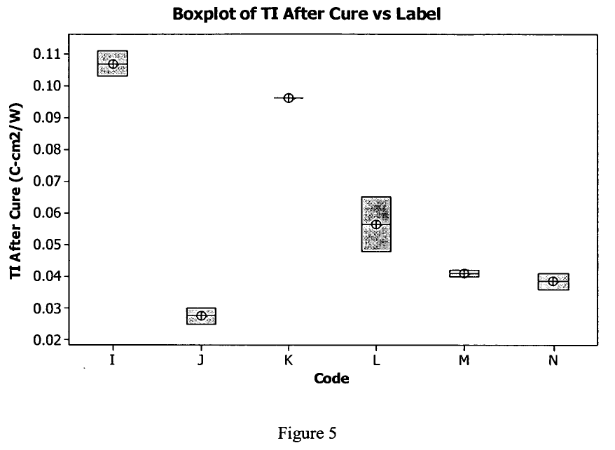

The effect of the chemical surface profile is shown in FIG. 4. Codes G and H are bare copper blocks and both have lower thermal impedance than the baseline nickel-plated blocks (code A). Code G was flycut which results in a microscopically smooth surface while code H has the same turned surface as the standard nickel-plated blocks. Codes I and J include gold plating over nickel-plating and have lower thermal impedance than the baseline blocks. Code I uses one gold-plated flycut block and one baseline nickel-plated block while code J uses two gold plated blocks. From this example it is evident that changes to the chemical surface profile can improve the thermal performance of a thermal interface material.

The effect of air exposure of the nickel-plated block after lapping is demonstrated in FIG. 5. These tests were conducted with one gold-plated block and one nickel-plated block except for code J (two gold-plated blocks) which is included for comparison. Limiting the air exposure to three hours before assembly (i.e. applying the TIM) and testing (code K) results in thermal impedance very slightly lower than an untapped block set. Storing the lapped blocks in a vacuum of 10-2 Pa for five hours before assembly and testing (code L) results in a dramatically lower thermal impedance. A shorter exposure time in air (five and two minutes for codes M and N respectively) reduces the thermal impedance even further to values approaching that of code J which was two gold-plated blocks. This set of examples shows that limiting oxidation of the nickel plated surface will dramatically decrease the thermal impedance of a thermal interface material/surface combination.

Thus, specific embodiments and applications of synergistically-modified surfaces and surface profiles, their methods of production, applications and uses have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A synergistically-modified surface having a surface profile, wherein the thermal contact resistance between the surface and at least one thermal interface material combination is lower than the thermal contact resistance between a non-synergistically-modified surface and thermal interface material combination.

2. The surface of claim 1, wherein the surface is modified through at least one of an additive process, a subtractive process or a combination thereof.

3. The surface of claim 2, wherein the additive process includes applying a coating composition or material, a metal or metal-based layer, a chemical treatment or a combination thereof.

4. The surface of claim 3, wherein the additive process includes electroplating, spot plating, plasma spray, melt spray, evaporation, sputtering, soldering, brazing, ultrasonic soldering or a combination thereof.

5. The surface of claim 2, wherein the subtractive process includes removing or displacing at least part of the surface material from the surface.

6. The surface of claim 5, wherein the subtractive process includes electro-etching, plasma etching, lapping, sanding, grinding, roughening or a combination thereof.

7. The surface of claim 5, wherein the process creates a surface roughness on the 0.5-20 micrometer scale.

8. The surface of claim 5, wherein oxidation of the surface is limited by applying the thermal interface material after the subtractive process.

9. The surface of claim 8, wherein oxidation of the surface is limited by applying a protective layer after the subtractive process and before applying the thermal interface material.

10. The surface of claim 5, wherein removing at least part of the surface material from the surface includes removing at least some of the surface material in a non-random manner.

11. A method of producing a synergistically-modified surface, comprising:
providing a surface having a surface profile,
providing at least one thermal interface material, and
synergistically modifying the surface profile of the surface such that the thermal contact resistance between the surface and the at least one thermal interface material is reduced as compared to the thermal contact resistance between a surface that is not synergistically modified and the at least one thermal interface material.

12. The method of claim 11, wherein the surface is modified through at least one of an additive process, a subtractive process or a combination thereof.

13. The method of claim 12, wherein the additive process includes applying a coating composition or material, a metal or metal-based layer, a chemical treatment or a combination thereof.

14. The method of claim 13, wherein the additive process includes electroplating, spot plating, plasma spray, melt spray, evaporation, sputtering, soldering, brazing, ultrasonic soldering or a combination thereof.

15. The method of claim 12, wherein the subtractive process includes removing at least part of the surface material from the surface.

16. The method of claim 15, wherein the subtractive process includes electro-etching, plasma etching, lapping, sanding, grinding, roughening or a combination thereof.

17. The method of claim 15, wherein removing at least part of the surface material from the surface includes removing at least some of the surface material in a non-random manner.

18. A layered component, comprising:
a synergistically-modified surface;
a thermal interface material; and
at least one additional layer of material.

19. The layered component of claim 18, wherein the at least one additional layer of material comprises a metal-based layer between the surface and the thermal interface material.

20. The layered material of claim 18, wherein the at least one additional layer of material comprises a protective layer coupled to the thermal interface material.

21. The layered material of claim 20, wherein the at least one additional layer of material comprises a protective layer coupled to the synergistically modified surface.

22. The layered material of claim 21, wherein the protective layer may be removed before application of the thermal interface material.

23. The layered material of claim 19, wherein the at least one additional layer of material additionally comprises a protective layer coupled to the thermal interface material.
